(19) United States
(12) Patent Application Publication
(10) Pub. No.: US 2004/0158876 A1
(43) Pub. Date: Aug. 12, 2004

(54) Apparatus and method for controlling program information display on electronic program guide screen

(76) Inventor: Shin-Jae Lee, Suwon-city (KR)

Correspondence Address: Robert E. Bushnell, Suite 300, 1522 K Street, N.W., Washington, DC, 20005-1202, US

(21) Appl. No.: 10/773,342

(22) Filed: Feb. 9, 2004

(30) Foreign Application Priority Data
Feb. 7, 2003 (KR) 10-2003-7928

(51) Int. Cl. H04N 7/173; H04N 7/16; H04N 7/00; H04N 11/00; H04N 7/08; H04N 5/445

(52) U.S. Cl. 725/136; 725/39; 725/50; 725/51; 725/116; 725/117; 725/137; 348/468

(57) ABSTRACT

An apparatus and a method for controlling a program information display on an electronic program guide (EPG) screen to supply perfect program information on the EPG screen to viewers by controlling length of the program information serviced through a set top box. A descriptor analysis is performed through SDT (service description table) and EIT (event information table) filtering processes for the corresponding channels by grouping channel IDs to be shown to the viewers on one screen. And, a display range of the program information is controlled by using length data of the program information obtained through the analysis processes, thereby showing the perfect program information to the viewers.

### CLAIM OF PRIORITY

This application makes reference to and claims all benefits accruing under 35 U.S.C. §119 from an application entitled APPARATUS AND METHOD FOR CONTROLLING CHANNEL INFORMATION DISPLAY ON ELECTRONIC PROGRAM GUIDE SCREEN earlier filed in the Korean Industrial Property Office on 7 Feb. 2003, and there duly assigned Serial No. 2003-7928 by that Office.

### BACKGROUND OF INVENTION

1. Field of the Invention

The present invention relates to an apparatus and a method for controlling a channel information display on an EPG (Electronic Program Guide) screen, and more specifically, to an apparatus and a method for controlling a program (event) information display on an EPG screen to supply perfect program information to users (viewers) from the EPG screen by controlling length of the program information serviced through a set top box.

2. Description of Related Art

Currently, a broadcasting service through a satellite (terrestrial broadcast) or a cable with the use of a set top box is supplied nearly all over the world. And, the number of services supplied by each service provider is continuously increasing. This means that program expertise to satisfy various personal tastes has been generalized and options for programs (events) are increasing as specific channels have been created. However, it is not easy for general users to understand information of such increased channels while watching on TV (television), because there aren't many texts to delicately show a lot of information compared to the size of the TV screen. In addition, though the information is displayed with graphics, enough information may not be delivered to users as much as possible owing to information displaying methods. Thus, the EPG screen is used for digital TV broadcasting to supply more channel information to viewers with a small number of texts.

Generally, on the digital TV broadcasting, all signals transmitted to homes from broadcasting stations as well as TV sets are digital signals, thereby supplying clear picture quality and vivid sound quality compared to an analog system. The digital broadcasting transmits multiplexed programs compressed according to MPEG (Moving Picture Experts Group) standards, among standards generated by the International Organization for Standardization/International Electrotechnical Commission (ISO/IEC).

MPEG-2 is an international standard to transmit various data and videos for advanced television broadcasting and satellite broadcasting. It is stipulated in the MPEG-2 that various signals for motion pictures, sounds, and other additional service information should be packetized as bit streams, which are divided into a program stream and a transport stream. Through multimedia communication using the MPEG-2, a transmitter loads a lot of information into the transport stream and delivers it, and a receiver extracts the loaded information by parsing the information with the transport stream including the information. Then, the extracted information is decoded. The transport stream includes program guiding information for each channel and time broadcasting as well as broadcasting programs for the digital TV broadcasting. In this case, the program information serviced by being included in such digital broadcasting signals is called electronic program guide (EPG) information.

One definition of EPG and SI (System Information) is ATSC PSIP. The program and system information protocol (PSIP) is an ATSC (Advanced Television Systems Committee) standard for terrestrial and cable digital broadcasting, defined to supply various information relating to programs by parsing messages encoded with an MPEG-2 method, as outlined, for example, in ATSC Standard Document A/65B “Program and System Information Protocol for Terrestrial Broadcast and Cable (Revision B),” by Advanced Television Systems Committee (Mar. 18, 2003).

The program and system information protocol (PSIP) is composed of many tables to transceive A/V (audio/video) data made in AC-3 audio and MPEG-2 video formats and to transmit information on channels and programs of each broadcasting station.

Also, the program and system information protocol (PSIP) can support a main function performing A/V services for desirous broadcast by selecting a channel and an electronic program guide (EPG) for broadcasting channels, that is, an additional function of broadcasting guide service. At this time, channel information for channel selecting and information on a packet identifier (PID) number for AN reception are transmitted through a VCT (Virtual Channel Table), while electronic program guide (EPG) information of the broadcasting programs of each channel is transmitted through an EIT (Event Information Table), respectively. Here, the EIT has titles, start time, etc., that are information on events of virtual channels. On this occasion, one event mostly indicates a typical TV program.

There may be up to 128 EITs, designated EIT-0 through EIT-127, each covering a 3 hour period. There are multiple instances of each EIT, one for each virtual channel.

Additionally, extended text table (ETT) information is optionally provided. That is, there may be one extended text table for each virtual channel and one for each event (TV program). Extended text table (ETT) information may provide channel extended text message (ETM) information and event extended text message (ETM) information. The channel extended text message (ETM) information includes a short explanation for each channel, and the event extended text message (ETM) information includes information on each program of the channels. And, the extended text table (ETT) information including the channel extended text message (ETM) information and/or the event extended text message (ETM) information is received from each physical channel (PC), if provided, and stored in an internal memory of a digital broadcasting receiver for selective display when changing channels.

Namely, when a user inputs a channel changing key signal to change a channel, channel information (channel ETM) on the changed channel as well as event (program) information (event ETM) on a currently broadcasted program is configured on a predetermined guide screen (for instance, channel banner screen), and is displayed on the screen for a preset predetermined time. Thus, the user can refer to the changed channel and program information of the corresponding channel.

A table configuring the EPG screen contains: an ID for each information table included in PSIP information, size of each information table and many VCs (Virtual Channels) included in a current physical channel, names for many channels existing in one frequency as well as channel numbers, modulating method, MGT (Master Guide Table)/VCT (Virtual Channel Table) composed of ID information of a transport stream corresponding to the channels, RRT (Rating Region Table) transmitting information on local and consultation organs for program ratings, ETM (Extended Text Message) including short explanation of each channel and information on each program of the channels, ETT (Extended Text Table) including channel ETM information and event ETM information, PAT (Program Association Table), and PMT (Program Map Table).

It is possible to obtain ETT information included in a program by clicking (selecting) a name of the program (program (event) title) in the EPG screen, in order to see ETT contents (channel and event ETM) information) of the EPG screen.

Meanwhile, the extended text table (ETT) information is transmitted in considerable size within program and system information protocol (PSIP) information, and is stored in the internal memory of the digital broadcasting receiver. In this case, when displaying the extended text table (ETT) information, not the entire extended text table (ETT) information but necessary information only is extracted by selection of a user (viewer), and is displayed on a predetermined guide screen.

That is, the user can selectively set a banner screen option including information contents of the banner screen composed of the extended text table (ETT) information as well as whether or not the information is displayed. For example, the user sets an information type (short or detailed information) of the displayed banner screen as well as whether or not the banner screen is displayed based on the extended text table (ETT) information during channel changing. Then, the digital broadcasting receiver selectively extracts necessary information only from the extended text table (ETT) information stored in the memory based on the banner screen information set by the user, and displays the extracted information.

Another example of EPG and SI (System Information) is DVB (Digital Video Broadcasting) SI, which united major players in the European broadcast market, according to a European Standard (Telecommunications Series):Digital Video Broadcasting (DVB); Specification for Service Information (SI) in DVB System, EN 300 468 V1.3.1, February 1998, and now includes participant from more than 30 nations worldwide.

DVB SI also includes tables, some of which are similar to those in ATSC PSIP. DVB-SI tables give service providers the tools necessary to offer programs and services across a large network of transport streams. These tables are added to the MPEG-2 transport stream during encoding or multiplexing and work together with MPEG-2 PSI (Program Specific Information) us tables. PSI tables act as a table of contents for the transport stream, providing a decoder with the data it needs to find each program and present it to the viewer. They do not provide enough information to support the numerous programs and services available on an entire network of transport streams. The DVB standard defines a set of tables (SI tables) that extend the capabilities of the MPEG-2 system layer such that a decoder can receive and decode any number of programs and services across a network of transport streams.

SI tables provide the information for the electronic program guide (EPG), which show viewers a description of all current and upcoming programs (event), along with there channel, start time and duration; and packets of the transport stream containing SI tables are identified by PID (packet identifier) numbers. The following table illustrates the various DVB SI tables and their PID.

| SI Tables | PID |
|---|---|
| Network Information Table (NIT)-shows the physical organization of | 0x0010 (or 0x10) |
| the network and its characteristics. | |
| Time and Date Table (TDT)-provides current UTC (co-ordinated | 0x0014 (or 0x14) |
| universal time) time. | |
| Service Description Table (SDT)-describes the services in a network | 0x0011 (or 0x11) |
| and gives name of the service provider. A service is a sequence of | |
| events that can be broadcast as part of a schedule. | |
| Event Information Table (EIT)-defines all events in the network, | 0x0012 (or 0x12) |
| providing their description, start time and duration. Used in creating | |
| EPG. | |
| Bouquet Association Table (BAT)-an optional table that describes | 0x0011 (or 0x11) |
| the services available in a given bouquet, or group of services that | |
| can be purchased as a single project. | |
| Running Status Table (RST)-an optional table that updates the timing | 0x0013 (or 0x13) |
| status of events when a schedule change occurs. | |
| Timing Offset Table (TOT)-an optional table that contains the UTC | 0x0014 (or 0x14) |
| time and date and the local time offset. | |
| Stuffing Table (ST)-an optional table that invalidates the remaining | 0x0010 to 0x0014 |
| sections of a table when one section has been overwritten. | (or 0x10 to 0x14) |

There are two types of service description tables (SDTs) required by DVB, “Actual” and “Other”. The SDT Actual describes the services available on the transport stream currently being accessed by the viewer, while the SDT Other describes services available on all other transport streams in the network.

Additionally, there are three types of event information tables (EITS) that can be transmitted simultaneously: the EIT Present, the EIT Following and the EIT Schedule. The EIT Present describes the events (TV programs) currently being broadcast on the transport stream being accessed by the viewer. The EIT Following provides information about the next events to be broadcast on the same transport stream. The EIT Schedule lists all events available on the network for the next few hours or the next few days, depending on the service provider's implementation. The EIT Schedule provides the main source of information for the EPG.

### SUMMARY OF THE INVENTION

It is an object of the present invention to provide an apparatus and a method for controlling a program information display on an electronic program guide screen to supply perfect program information to users (viewers) from the EPG screen by controlling length of the program information serviced through a set top box.

To accomplish the above object, according to one embodiment of an apparatus for controlling a program information display on an electronic program guide screen in accordance with the present invention, the apparatus comprises: a demultiplexer demultiplexing a received transport stream, and extracting service description table (SDT) information and event information table (EIT) information from the demultiplexed data; a main processor detecting length of program information from the SDT information and the EIT information extracted from the demultiplexer; and display controller processing the program information to be displayed on an EPG by corresponding to the length of the program information detected from the main processor, and transmitting the program information to a CRT.

The main processor comprises: an Service description table (SDT) input unit inputting the SDT information transmitted from the demultiplexer; a service ID searcher searching a service ID of a current transport stream by using PID (0x11) and SDT Actual table ID (0x42) of the SDT information inputted through the SDT input unit; a table parsing unit parsing a table of a selected service with the service ID searched from the service ID searcher, and extracting a service descriptor; and a service name length extractor analyzing the service descriptor extracted from the table parsing unit, and extracting length of a service name.

Also, the main processor comprises: an EIT input unit inputting the EIT information transmitted from the demultiplexer; a service ID searcher searching an event ID from the EIT information inputted through the EIT input unit; a table parsing unit parsing an EIT like PID (0x12) and Table ID (0x4E, 0x50˜0x5F) of EIT present and following actual or EIT schedule actual, with the event ID searched in the service ID searcher, and extracting short_event_descriptor (0x4D) of a corresponding event; and an event name length extractor analyzing the short_event_descriptor (0x4D) extracted from the table parsing unit, and extracting length of an event name.

In addition, according to one embodiment of a “method for controlling a program information display on an electronic program guide screen”, the method comprises: a first step of demultiplexing a received transport stream, extracting service description table (SDT) information and event information table (EIT) information, and detecting length of program information from the extracted SDT information and the EIT information; a second step of confirming whether it is possible to display the length of the detected program information in a restricted region, when the program information is requested to be displayed within a table cell; a third step of displaying the program information by applying a program information display method of a general EPG, if the length of the detected program information can be displayed in the restricted region after confirming in the second step; and a fourth step of displaying the program information by dividing the program information into displayable length units, if the length of the detected program information cannot be displayed in the restricted region after a confirmed result in the second step.

The fourth step comprises the sub-steps of: dividing the program information into displayable length units, if the length of the detected program information cannot be displayed in the restricted region; displaying program information stored in a first display unit buffer of the program information; checking whether displaying of a final unit of the divided program information is completed, and displaying program information stored in a next display unit buffer, if not completed after a checked result; and finishing displaying the program information after displaying the final unit of the divided program information after the checked result.

Also, according to another embodiment of a “method for controlling a channel information display on an electronic program guide screen” by the present invention, the method comprises: a first step of demultiplexing a received transport stream, extracting service description table (SDT) information and event information table (EIT) information, and detecting length of program information from the extracted SDT information and the EIT information; a second step of confirming whether it is possible to display the length of the program information detected in the first step in a restricted region, if the program information is requested to be displayed within a table cell; a third step of displaying the program information by applying a program information display method of a general EPG, if the length of the detected program information can be displayed in the restricted region after confirming in the second step; a fourth step of creating a display range window of displayable length, if the length of the detected program information cannot be displayed in the restricted region after a confirmed result in the second step; and a fifth step of displaying the program information as moving the display range window created in the fourth step.

The fifth step comprises the sub-steps of: displaying a part to be displayed with the display range window from a first position of the table cell; checking whether the display range window displays all the program information to the end, and finishing the procedure if a final part of the program information is completely displayed; and displaying the program information by moving a program information display window at regular intervals, if the program information to be displayed exists after a checked result.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is an example diagram of an electronic program guide (EPG) screen implemented in a representative digital TV system;

FIG. 2 is a diagram illustrating a representative example of an operational flowchart of a method for controlling a program information display on an electronic program guide (EPG) screen of FIG. 1;

FIG. 3 is a diagram illustrating a block configuration of an apparatus for controlling a program information display on an electronic program guide screen in accordance with the present invention;

FIG. 4 is a diagram illustrating a block configuration of an apparatus for extracting length of a service name with Service description table (SDT) information from a main processor of FIG. 3;

FIG. 5 is a diagram illustrating a block configuration of an apparatus for extracting length of an event name with EIT information from a main processor of FIG. 3;

FIG. 6 is a diagram illustrating an operational flowchart of a method for controlling a program information display on an electronic program guide screen in accordance with a first embodiment of the present invention;

FIG. 7 is a diagram for describing a of a display unit division of program information in the present invention;

FIG. 8 is a diagram for describing a display of first program information when the program information is divided into display units like FIG. 7;

FIG. 9 is a diagram for describing a display of second program information when the program information is divided into display units like FIG. 7;

FIG. 10 is a diagram illustrating an operational flowchart of a method for controlling a program information display on an electronic program guide screen in accordance with a second embodiment of the present invention;

FIG. 11 through FIG. 13 are diagrams for describing a process of displaying program information from the start to the end by moving a display range window like FIG. 10.

### DETAILED DESCRIPTION OF EXEMPLARY EMBODIMENTS

Reference will now be made in detail to exemplary embodiments of the present invention, which are illustrated in the accompanying drawings.

So as to display perfect program information on an electronic program guide (EPG) in accordance with the present invention, it is necessary to display the program information without loss by algorithm of analyzing substantially transmitted information and efficiently sending analyzed results to viewers. To do this, a descriptor analysis should be performed through Service description table (SDT) and EIT filtering processes for channels by grouping IDs of the channels to be shown to viewers on one screen, and a display range is controlled for perfect displaying by using length data of the program information obtained through the analysis processes.

According to EN 300 468 V1.3.1, names and length corresponding to events (programs or TV programs) and services should be specified in a short_event_descriptor and a service_descriptor, respectively. Also, with the DVB standard, a descriptor having a name and length used in a private_descriptor defined and used by a provider has contents and length information, and event and service names used in a multilingual descriptor have likewise.

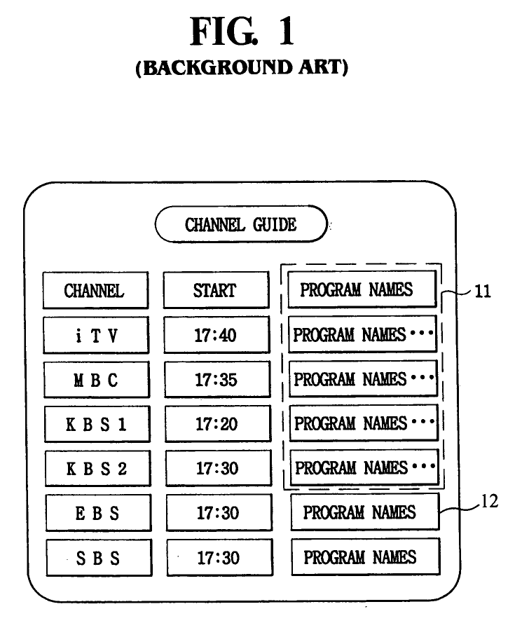

FIG. 1 is a representative example of a format diagram of an EPG screen implemented in a exemplary digital TV system. As shown in FIG. 1, channel names showing broadcasting stations are displayed, program names provided from the corresponding broadcasting stations are displayed, and start time of programs is displayed.

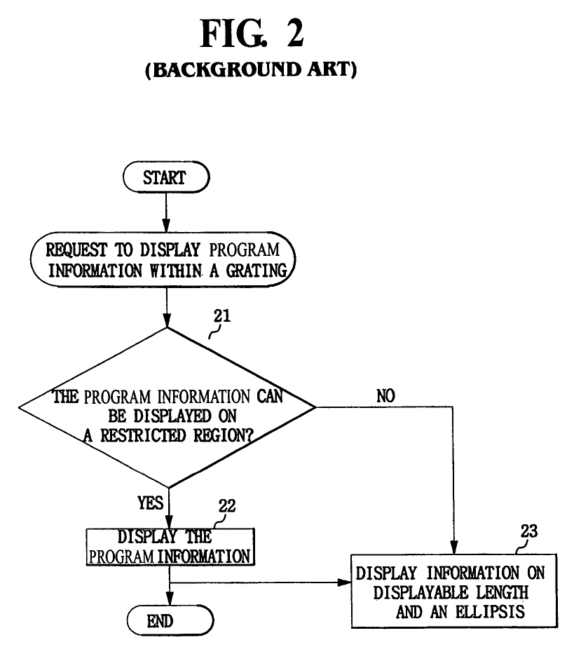

FIG. 2 is a diagram illustrating a representative example of an operational flowchart of a method for controlling a program information (program title) display on an electronic program guide (EPG) screen.

As shown in FIG. 2, when program information is requested to be displayed in a grating (table cell), it is confirmed whether the program information can be displayed in such a restricted region (step 21). If the program information can be displayed in the restricted region, the program information is displayed (step 22). If the program information cannot be displayed in the restricted region, the program information is displayed by inserting an ellipsis mark (i.e., . . . or . . . ) to the back end of displayable length of program information (step 23) thereby indicating part of the information is omitted.

The method for controlling a program information (event information) display on an electronic program guide (EPG) screen in accordance with the foregoing examples will be more fully described as follows.

When the program information is requested to be displayed within the grating, in step 21 it is checked whether the entire length of the program information to be displayed can be displayed in the restricted region (e.g., the table cell (grating) containing the program title, such cell being restricted in size). If the entire program information can be displayed in the restricted region, for instance, when a program name corresponding to the EBS channel in FIG. 1 is selected, the program information is displayed within the grating 12, as it is, (step 22).

However, if the entire program information cannot be displayed in the restricted region, like program information in the table cells (gratings) enclosed by the dotted line block 11 shown in FIG. 1, an ellipsis ( . . . ) is added to back of the displayable length of the program information. Thus, the program information is displayed by omitting a portion of the program information (step 23).

In such a case, the user may not see that portion of the program information that is omitted from being displayed on the screen. This phenomenon can occur in different types according to kinds of EPGs (electronic program guides), but many current EPGs have restrictions like above.

In a restricted information loss-type display method described above, it occurs frequently that program information, a basic object of program guides, cannot be properly displayed. Also, viewers may not obtain enough program information as desired, and in some cases, the EPG itself becomes useless.

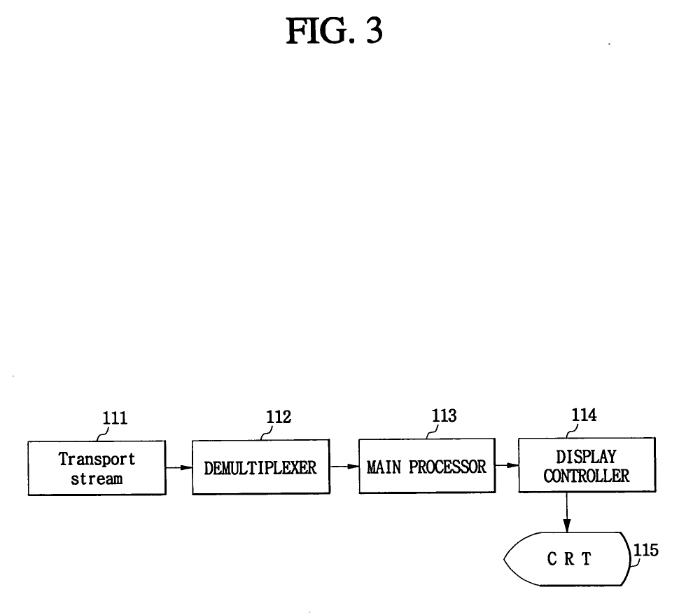

FIG. 3 is a diagram illustrating a block configuration of an apparatus for controlling program information display on an electronic program guide (EPG) screen in accordance with the present invention.

As shown in FIG. 3, the apparatus comprises: a demultiplexer 112 demultiplexing a received transport stream 111, and extracting service description table (SDT) information and event information table (EIT) information from the demultiplexed data; a main processor 113 detecting the length of the program information from the SDT information and the EIT information extracted by the demultiplexer 112; and a display controller 114 processing the program information to be displayed on an EPG screen by utilizing the length of the program information detected by the main processor 113, and transmitting the program information to a video screen, such as cathode ray tube (CRT) 115.

An operation of the apparatus for controlling the program information display on the electronic program guide (EPG) screen by the present invention will be more fully described as follows.

The demultiplexer 112 demultiplexes the transmitted transport stream 111, extracts the service description table (SDT) information and the event information table (EIT) information from the demultiplexed data, and transmits the SDT information and the EIT information to the main processor 113.

The main processor 113 extracts data corresponding to the length of a service name and the length of an event name by using the transmitted SDT information and the EIT information. Thus, the length of the program information is extracted.

First, a process of extracting the length of the service name from the service description table (SDT) information will be described in detail as follows.

Each channel shown on a screen has an assigned ID. With these IDs, descriptors containing length information of a service name of a current channel can be analyzed.

In another words, a service ID of a current transport stream is searched by using a packet identifier (PID) (0x11) and an SDT Actual table ID (0x42) of the inputted service description table (SDT) information. When analyzing a service_descriptor in a selected service with the searched service ID, the length of the service name is obtained.

An Algorithm below shows the process of extracting the length of the service name from the SDT information.

```
Service_description_Table {
    table_id
    transport_stream_id
    original_network_id
    service_descriptor_loop{
        service_id
        descriptor_loop{
            service_descriptor
            linkage_descriptor
            NVOD_reference_descriptor
            time_shifted_service_descriptor
            private_data_specifier_descriptor
        }
    }
}
```

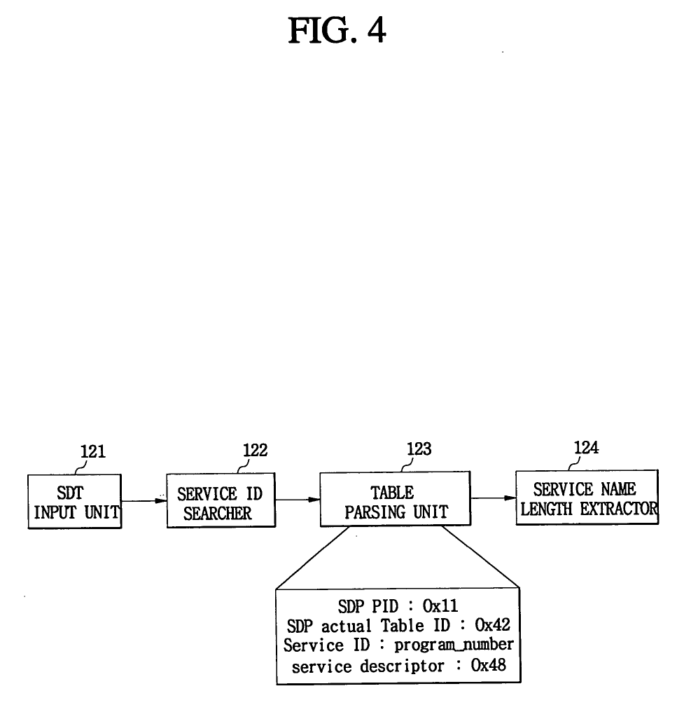

FIG. 4 is a diagram illustrating a block configuration of an apparatus for extracting the length of the service name by the SDT information in the main processor 113 of FIG. 3.

As shown in FIG. 4, an SDT input unit 121 inputs the SDT information transmitted from the demultiplexer 112 of FIG. 3. A service ID searcher 122 searches a service ID of a current transport stream by using PID (0x11) and SDT Actual table ID (0x42) inputted through the SDT input unit 121.

Next, a table parsing unit 123 parses a table of the selected service with the searched service ID, and a service name length extractor 124 extracts the length of the service name by analyzing the parsed table, and transmits the extracted length to the display controller 114 of FIG. 3.

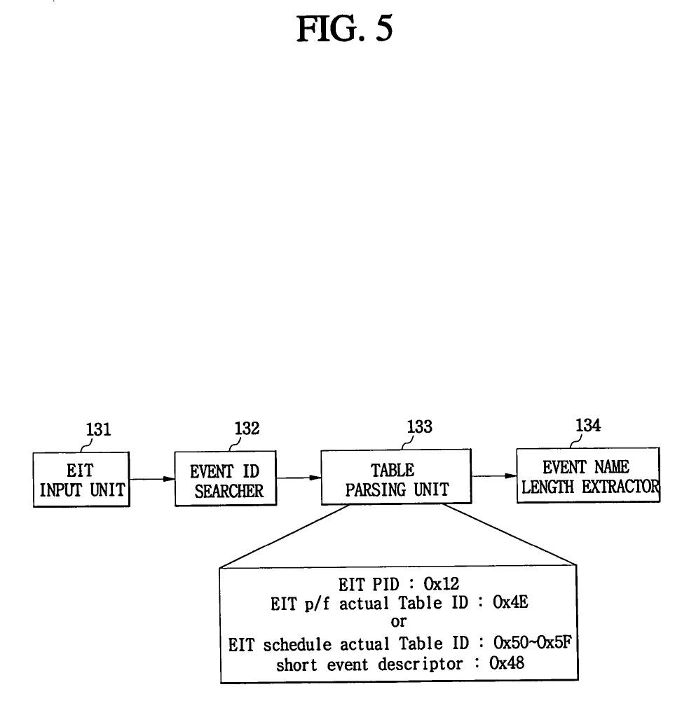

And, a process of extracting length of an event name from EIT information will be more fully described in reference to FIG. 5.

FIG. 5 is a diagram illustrating a block configuration for extracting the length of the event name by the EIT information from the main processor 113 of FIG. 3.

As shown in FIG. 5, an EIT input unit 131 inputs the EIT information transmitted from the demultiplexer 112 of FIG. 3, and a service ID searcher 132 searches an event ID from the EIT information inputted through the EIT input unit 131.

Next, a table parsing unit 133 parses an EIT PID (0x12) and Table ID (0x4E, 0x50˜0x5F) of and EIT present and following p/f) Actual or EIT schedule Actual with the searched event ID, and extracts a short_event_descriptor (0x4D) of a corresponding event.

Then, an event name length extractor 134 extracts the length of the event name by analyzing the short_event_descriptor (0x4D) extracted from the table parsing unit 133, and transmits the extracted length to the display controller 114 of FIG. 3.

After that, the display controller 114 displays the event name or the service name inside of a restricted table cell on the EPG. Here, if the length of the extracted service name or the event name is smaller than the size of the displayed restricted table cell, all the program information is displayed in the cell.

However, if the length of the extracted service name or the event name is bigger than the size of the displayed table cell, the program information is displayed by being divided into displayable length units, or in another method, a display range window of displayable length is created. Then, the program information is displayed as moving the created display range window, so that viewers can easily know all the program information.

The Algorithm below shows the process of extracting the length of the event name from the EIT information.

```
Event_Information_Table {
    table_id
    transport_stream_id
    original_network_id
    last_section_id
    event_descriptor_loop{
        event_id
        descriptor_loop{
            short_event_descriptor
            extended_event_descriptor
            content_descriptor
            parent_rating_descriptor
            NVOD_reference_descriptor
        }
    }
}
```

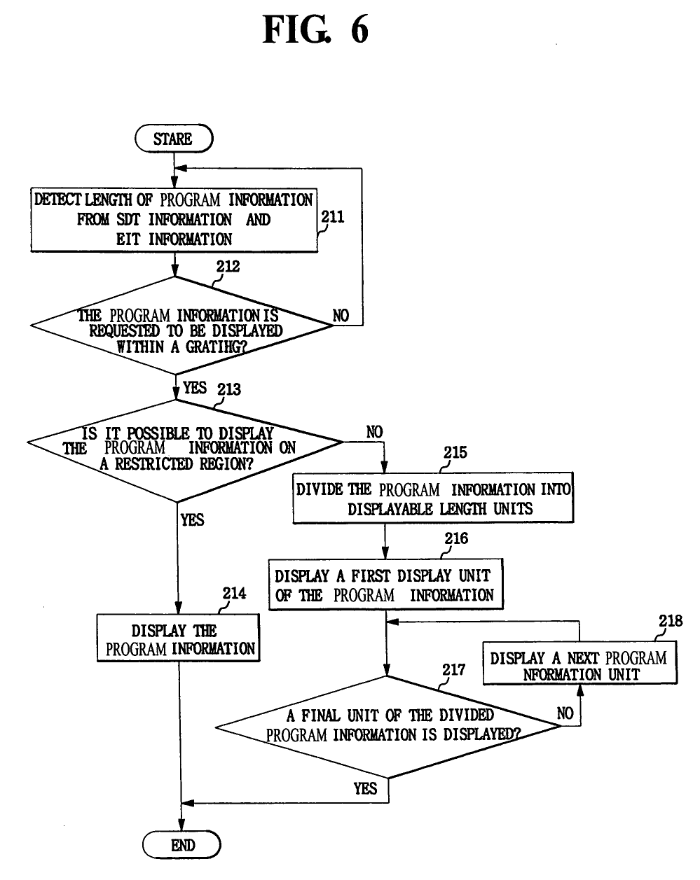

FIG. 6 is a diagram illustrating an operational flowchart of a method for controlling a program information display on an electronic program guide screen in accordance with a first embodiment of the present invention.

As shown in FIG. 6, first, after demultiplexing a received transport stream, service description table (SDT) information and event information table (EIT) information are extracted, and length of program information is detected from the extracted SDT and EIT information (step 211).

It is checked whether the program information is requested to be displayed within a table cell (step 212). If the program information is requested to be displayed within the table cell, it is confirmed whether the length of the detected program information can be displayed in a restricted region (step 213).

So, if the length of the detected program information can be displayed in the restricted region, the program information is displayed by applying a program information display method of a general EPG (step 214).

However, if the length of the detected program information cannot be displayed in the restricted region, the program information is divided into displayable length units (step 215).

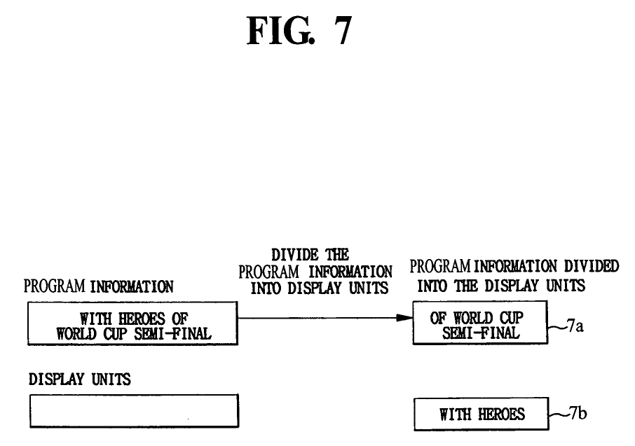

In this case, many display unit buffers having the same size as the displayable size of the table cell are created, and divided portions of the event or service name information is respectively assigned to each display unit buffer, as will be discussed below with respect to FIG. 7 and steps 216-218.

FIG. 7 is a diagram for describing a display unit division of program information in accordance with the present invention. As shown in FIG. 7, if program information (for instance, “With Heroes Of World Cup Semi-final”) to be displayed is bigger than the restricted region, the restricted region (table cell) having a predetermined number of display units (or pixels)), many buffers (7a and 7b) corresponding to display units are created, and the program information is assigned to each display unit buffer (7a and 7b) by dividing the program information. For example, program information such as “Of World Cup Semi-final” is assigned to a first display unit buffer (7a), and program information such as “With Heroes” is assigned to a second display unit buffer (7b).

Then, as shown in FIG. 6, the program information stored in the first display unit buffer of the program information is displayed (step 216). It is checked whether displaying of a final unit of the same divided program information is completed (step 217). If not completed, program information stored in a next display unit buffer is displayed (step 218). After displaying the last displayable unit of divided program information, the process ends, or returns to step 211.

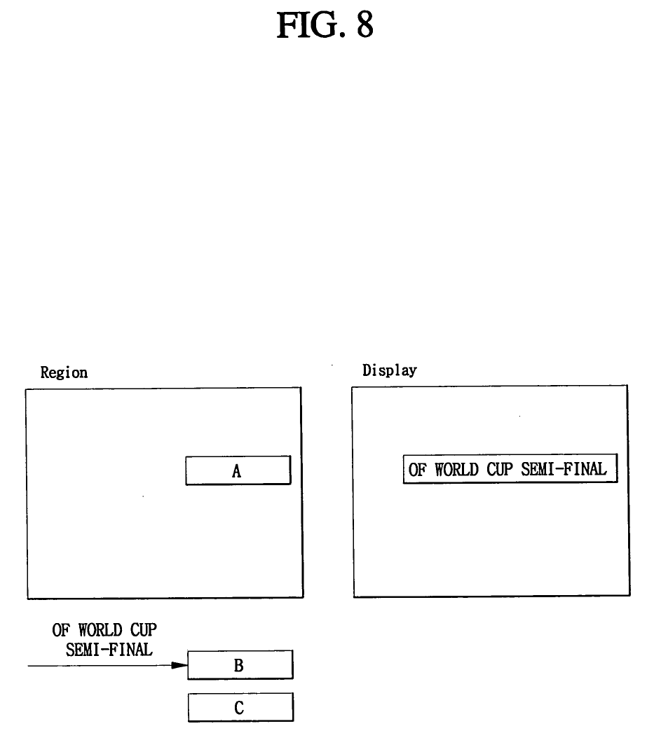

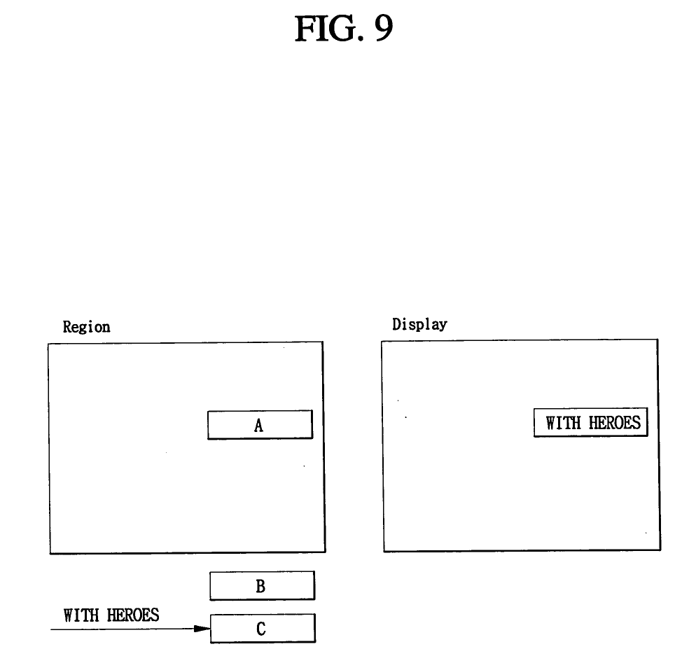

FIG. 8 is a diagram for describing a display of first program information, and FIG. 9 is a diagram for describing a display of second program information.

As shown, supposing program information to be displayed is bigger than the number of display units available in the corresponding table cell, and divided program information corresponds to two display unit buffers, program information stored in a first display unit buffer (7a) is firstly displayed as shown in FIG. 8. Next, as shown in FIG. 9, program information stored in a second display unit buffer (7b) is displayed.

Thus, viewers can confirm perfect program information even in a restricted table cell.

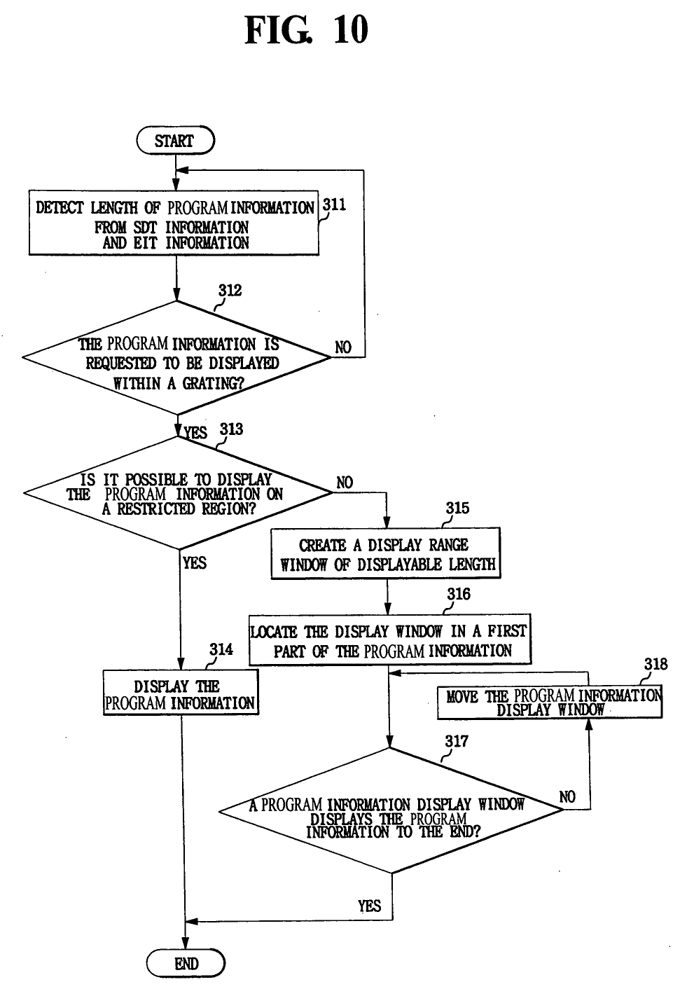

FIG. 10 is a diagram illustrating an operational flowchart of a method for controlling a program information display on an electronic program-guide screen in accordance with a second embodiment of the present invention.

As shown in FIG. 10, first, a received transport stream is demultiplexed, service description table (SDT) information and event information table (EIT) information are extracted, and length of program information is detected from the extracted SDT information and the EIT information (step 311).

It is checked whether the program information is requested to be displayed within a table cell (step 312). If the program information is requested to be displayed within the table cell, it is confirmed whether the length of the detected program information can be displayed in the restricted region of the table cell (step 313).

If the length of the detected program information can be displayed in the restricted region, the program information is displayed by applying a program information display method of a general EPG (step 314).

However, if the length of the detected program information cannot be displayed in the restricted region, a display range window 411 of predetermined displayable length is created (step 315).

Next, a part of the program information to be shown within the display range window is displayed from a first position of the table cell (step 316). Here, the display range window displays program information corresponding in size to the size of the table cell and starts the display process from the start of an event or service information.

It is then checked whether the display range window 411 displays all the program information to the end (step 317) of the event or service information. If displaying of a final part of the program information is completed, the process finishes. On the contrary, if program information to be displayed still remains, the program information is displayed by moving the display range window 411 at regular intervals (step 318).

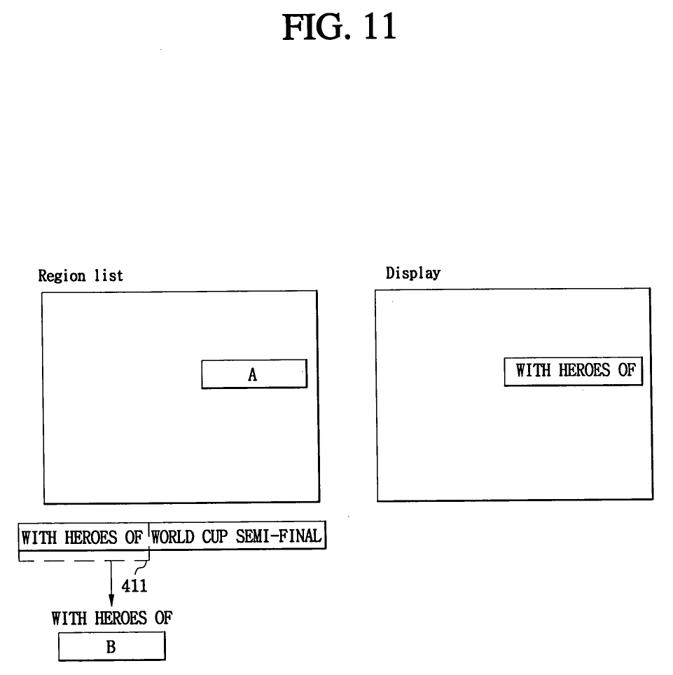

FIG. 11 through FIG. 13 are diagrams for describing a process of displaying program information from the start to the end by moving a display range window.

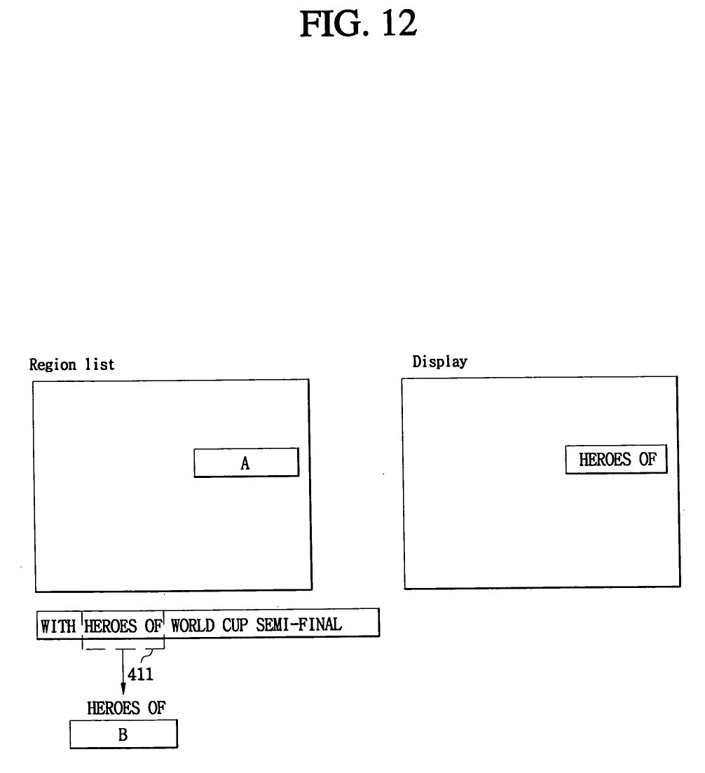

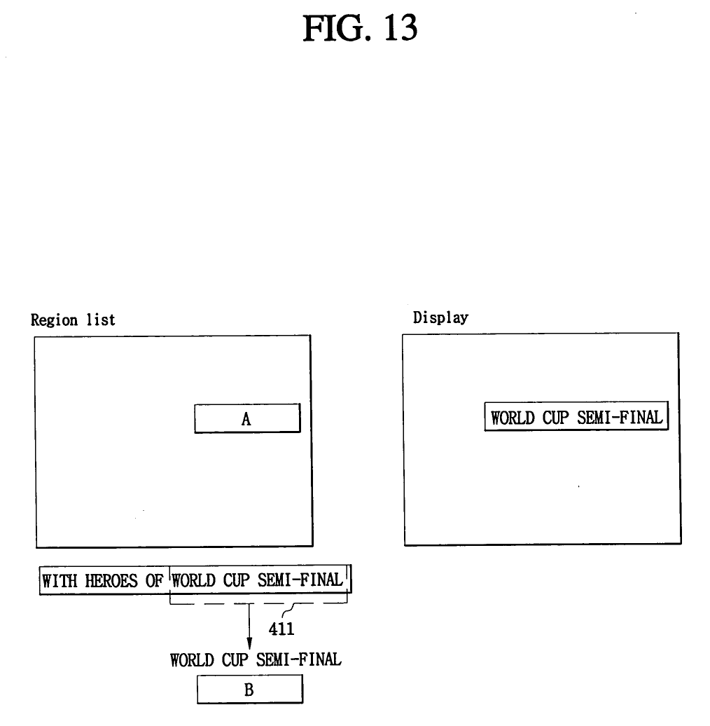

FIG. 11 shows a displayed state when the display range window is located in a first part of the program information, and FIG. 12 shows a state of displaying program information of a next part by the moved display range window, then FIG. 13 shows a state of displaying program information of a final part by the moved display range window.

In the above embodiment, the program information is displayed on a displaying region at preset time intervals by presetting time when the program information is displayed, however, it is easily understood for those skilled in the art that the displaying time can be optionally reset by users.

In addition, though a digital TV broadcasting system has been described by applying the European digital TV (DVB SI) broadcasting systems as an example in the above embodiment, it can also be applied to the United States system (ATSC PSIP). That is, a core of the present invention is how to display program information rather than the digital TV broadcasting system. So it will be easily understood for those skilled art that differences of the digital TV broadcasting system have nothing to do with the present invention.

According to “an apparatus and a method for controlling a program information display on an electronic program guide screen” by the present invention described so far, it is possible to effectively display program information serviced through a set top box. Therefore, it can resolve inconvenience of displaying restricted information, which users often feel when using an existing set top box.

Furthermore, it is possible to supply optimal program information according to a function of supplying the most fundamental program information of an EPG used in the set top box.

What is claimed is:

1. An apparatus for controlling a program information display on an electronic program guide (EPG) screen, comprising:
a demultiplexer demultiplexing a received transport stream, and extracting service description table (SDT) information and event information table (EIT) information from the demultiplexed data;
a program information length detector detecting length of the program information from the service description table (SDT) information and the event information table (EIT) information extracted from the demultiplexer; and
a display controller processing the program information to be displayed on an electronic program guide (EPG) by corresponding to the length of the program information detected from the program information length detector, and transmitting the program information to a video display device.

2. The apparatus of claim 1, wherein the program information length detector searches a service ID of a current transport stream by using PID (0x11) and SDT Actual table ID (0x42) of the inputted service description table (SDT) information, analyzes a service_descriptor in a selected service with the searched service ID, and extracts length of a service name.

3. The apparatus of claim 1, wherein the program information length detector comprises: an service description table (SDT) input unit inputting the service description table (SDT) information transmitted from the demultiplexer;
a service ID searcher searching a service ID of a current transport stream by using the PID (0x11) and SDT Actual table ID (0x42) of the service description table (SDT) information inputted through the service description table (SDT) input unit;
a table parsing unit parsing a table of a selected service with the service ID searched in the service ID searcher, and extracting a service descriptor; and
a service name length extractor analyzing the service descriptor extracted from the table parsing unit, and extracting length of the service name.

4. The apparatus of claim 1, wherein the program information length detector extracts short_event_descriptor (0x4D) of a corresponding event with PID (0x12) and Table ID (0x4E, 0x50˜0x5F) of EIT present and following actual or EIT schedule actual of the inputted EIT information, and extracting length of an event name by analyzing the extracted short_event_descriptor.

5. The apparatus of claim 1, wherein the program information length detector comprises: an EIT input unit inputting the event information table (EIT) information transmitted from the demultiplexer;
a service ID searcher searching an event ID in the event information table (EIT) information inputted through the EIT input unit;
a table parsing unit parsing event information table (EIT) like the PID (0x12) and the Table ID (0x4E, 0x50˜0x5F) of EIT present and following actual or EIT schedule actual with the event ID searched in the service ID searcher, and extracting the short_event_descriptor (0x4D) of the corresponding event; and
an event name length extractor analyzing the short_event_descriptor (0x4D) extracted from the table parsing unit, and extracting length of an event name.

6. A method for controlling a program information display on an electronic program guide screen, the method comprising:
a first step of demultiplexing a received transport stream, extracting service description table (SDT) information and event information table (EIT) information from the demultiplexed data, and detecting length of program information from the extracted SDT information and the EIT information;
a second step of confirming whether it is possible to display the length of the detected program information in a restricted region, when the program information is requested to be displayed within a table cell; and
a third step of dividing the program information into displayable length units, if the length of the detected program information cannot be displayed in the restricted region after confirming, and displaying the divided program information.

7. The method of claim 6, wherein the third step comprises the sub-steps of:
dividing the program information into the displayable length units, if the length of the detected program information cannot be displayed in the restricted region;
displaying program information stored in a first display unit buffer of the program information;
checking whether displaying of a final unit of the divided program information is completed, and displaying program information stored in a next display unit buffer, if not completed after a checked result; and
completing the program information display after displaying the divided program information to the end after the checked result.

8. The method of claim 6, wherein in the second step, a fourth step of displaying all the detected program information in the restricted region, if the length of the detected program information can be displayed on the region, is further comprised.

9. A method for controlling a program information display on an electronic program guide screen, the method comprising:
a first step of demultiplexing a received transport stream, extracting service description table (SDT) information and event information table (EIT) information from the demultiplexed data, and detecting length of program information from the extracted SDT information and the EIT information;
a second step of confirming whether it is possible to display the length of the detected program information in a restricted region, when the program information is requested to be displayed within a table cell;
a third step of creating a display range window of displayable length, if the length of the detected program information cannot be displayed in the restricted region after a confirmed result in the second step; and
a fourth step of displaying the program information as moving the display range window created in the third step.

10. The method of claim 9, wherein the fourth step comprises the sub-steps of:
displaying a part to be shown with the display range window from a first position of the table cell;
checking whether the display range window displays all the program information to the end, and completing a display operation if all the program information is displayed; and
displaying the program information by moving a program information display window at regular intervals, if program information to be displayed still remains after a checked result.

11. The method of claim 9, wherein the display range window displays the program information as much as corresponding size of the table cell from the start of event or service information.

12. The method of claim 9, wherein the second step comprises displaying all the detected program information in the restricted region, if the length of the detected program information can be displayed on the region.
